(19) United States
(12) Patent Application Publication
(10) Pub. No.: US 2003/0054821 A1
(43) Pub. Date: Mar. 20, 2003

(54) Manager for controlling wireless network, processing device, device and medium

(75) Inventors: Tatsuya Kita, Kawasaki (JP); Tadao Tsuchimura, Kawasaki (JP); Takanori Terada, Kawasaki (JP); Shinpei Uno, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/102,678

(22) Filed: Mar. 22, 2002

(30) Foreign Application Priority Data
Sep. 18, 2001 (JP) 2001-284012

(51) Int. Cl. H04Q 7/20

(52) U.S. Cl. 455/435; 455/560; 455/41

(57) ABSTRACT

A manager (1) for controlling a wireless network to which a processing device (2 through 4) is connected comprises a registration module (35, 38) registering the processing device (2 through 4) connected to the wireless network, a wireless communication module (40) communicating with the processing device (2 through 4), a search module (31) searching a processing device (2 through 4) existing within a communicable range through the wireless communication module (40) and a connection control module (31) connecting, when the searched processing device (2 through 4) is registered in the registration module (35, 38), the searched processing device (2 through 4) to the wireless network.

### BACKGROUND OF THE INVENTION

The present invention relates to a wireless communication network.

A network based on Bluetooth specifications and a wireless LAN are known as wireless communication networks. In the network based on the Bluetooth specifications, when connecting a plurality of devices to the network, a hierarchical relationship such as a master and a slave exists between these devices.

Then, in the network based on the Bluetooth specifications, a device capable of making connections of the plurality of devices at the same time, is defined as a master. This device may also be called a device in a master status or a master device.

Further, the device connected to the master device, e.g., one device among the plurality of devices connected to the master device, is defined as a slave. This device may be called a device in a slave status or a slave device. The slave device is unable to be connected-to a device other than the master device. Characteristics of the master device and the slave device will hereinafter be listed up.

Master Device:

(1) The master is a status of the device connectable to the plurality of devices.

(2) Basically, when the device itself gives a connection request to a co-communication device, this device schemes to become the master. If the co-communication device is not connected to other device, this requester device is connected intact as the master to the co-communication device.

(3) If the co-communication device has already been connected as the slave, the connection request is rejected.

(4) If the co-communication device has already been connected as the master to other device and when giving the connection request to this master device, the master device issues a notification that “the connection be permitted if the requester device can become the slave”. In this case, if the connection requester device is being connected to other device, the requester device needs to be disconnected from all the on-connection devices in order to become the salve, and hence the connection is not normally established. Further, if able to become the slave, the requester device is connected automatically as the slave.

(5) The device issuing the connection request to the co-communication device is, however, able to make such a request that “the device itself be the salve”. In this case, if in a condition where the connection request issuing device becomes the slave and in a condition where the co-communication device becomes the master, the connection requester device temporarily becomes the master and thereafter, with an occurrence of RoleChange, changes into the slave. On the other hand, the connection requested device temporarily becomes the slave and thereafter, with the occurrence of RoleChange, becomes the master back.

Slave Device:

(1) The slave device is a device in such a status that this device can be connected to only one master device.

(2) Basically, the device to which the co-communication device is connected becomes the slave. If the device itself is being connected as the master, however, in response to the connection request from the co-communication device, this device replies that “the connection request be permitted if the requester device is able to become the slave”.

(3) Further, the device issuing the connection request to the co-communication device can make such a request that “the device itself be slave”.

Based on the relationships described above, the number of the devices simultaneously connectable to the individual device is limited.

The device-to-device relationship will hereinafter be explained referring to FIG. 1. For example, a certain device 1 makes such a request that the device 1 itself is connected as the master to other device 2 as the slave. If the device 2 accepts this request, the connecting device 1 becomes the master, while the connected device 2 becomes the slave. The device 1 is the master and is therefore able to connect further to other device 3, and the device 3 also falls into the slave status.

The master is the device capable of simultaneously connecting to the plurality of devices as the slaves.

In this case, the devices 2, 3 are the slaves. The slave is the device which is connected to the master device. The slave is unable to connect to the device other than the master and to receive the connection thereof.

There is, however, a system in which if the connection request is given to the master device 1 from the device 4, the device 4, after being changed into the slave status by issuing a RoleChange event, can be connected as the slave. In this case, the problem described above does not arise. This can not be, however, expected at all times. Further, in the network-configured environment, if the device 4 searches for peripheral devices, it follows that a tremendous number of devices are discovered, and it is quite difficult to specify an unknown master device 1.

Given herein is an explanation of a case where other device tries to connect with a device connected in the master-to-slave relationship based on the present Bluetooth specifications. If the connection request is given to a certain device assuming the slave status at the present, this request is invariably rejected. When scheming to connect with the slave device, the present connection is canceled by any one of this slave device or the master device above this slave, and it is required that this hierarchical relationship be obviated.

Now, when giving the connection request to the master device, the master can take an option, i.e., accept or reject the connection. A general option is that the master normally rejects the connection. Further, if the master accepts the connection, this master changes into a connected device, i.e., the slave. Then, the connections remaining connected to other devices so far are forcibly cut off.

The following is a procedure of configuring a wireless network (which is also called a piconet) using the devices exhibiting the above properties on the basis of the Bluetooth specifications.

1) The master device 1 is installed as a host in the network (e.g., a telephone line is linked to this master device 1 in a dialup environment where a plurality of devices are connected to one single dialup router etc).

2) The master device 1 connects with the devices 2, 3 defined as network configuring members, wherein the devices 2, 3 are connected as the slave devices.

There will be described a scheme of “newly connecting the device 4” to the wireless network configured in this state.

3) The device 4 as the want-to-connect-with-the-network device is moved to within a communicable range of the device 1.

4) If the connection request is given to the master device 1 from the device 4 as it is, however, the device 4 is unable to connect with the network. It is because the master device 1 normally reject this request.

If the master device 1 herein accepts the request, as described above, the master device 1 changes into the slave status, and the devices 2, 3 are forcibly disconnected. Hence, this network turns out to be a network that might be suddenly forcibly disconnected.

5) For connecting with the network, the master device 1 in this state must perform a procedure such as [searching for the device 4]→[discovering]→[connecting]. Namely, an owner of the device 4 takes a trouble to request an administrator of the master device for searching→connecting.

6) As a matter of course, the devices 2, 3 are the slaves and therefore unable to receive the connections.

Thus, according to the conventional method, the new connection of the device 4 to the network configured by the existing master device 1 involves not only moving the device 4 to within the communicable range of the master device 1 but also operating the master device 1. In the normal network, there is a necessity of requesting the administrator of the master device 1 to perform the connecting operation each time. Hence, the environment must be inconvenient to a case where a non-fixed model network is temporarily configured by, e.g., PDAs, personal computers and others.

For obviating this problem, a system is disclosed in, e.g., Japanese Patent Application Laying-Open Publication No.2001-168881, wherein a device as a slave device desiring for a connection to a piconet searches for a master device and requests the master device for the connection.

If a device (e.g., a mobile PC etc) based on the Bluetooth specifications tries to connect with a peripheral piconet and if there are a plurality of piconets around this target piconet, this device might mis-target the connection target piconet and enter an unintentional piconet. In this case, the device must be disconnected from the erroneous piconet and reconnected to the target piconet.

The technology disclosed in the above Publication schemes to obviate the problem described above, wherein connection locating information of the connection target piconet is obtained just before the connection, and a connecting destination (piconet) desired by the device itself is selected, thereby obviating this inconvenience. Namely, the technology disclosed in the above Publication provides a “network in which the device entering as the slave is able to select an arbitrary connecting destination (piconet)”.

### SUMMARY OF THE INVENTION

In a normal network system, however, a master device generally limits the number of clients of which connections to a self-network are permitted for conveniences in terms of security and resources inclusive.

In such a case, according to the technology disclosed in the Publication described above, the device selects the connection target and connects thereto, however, the connection is not basically approved even when a connection request is given from an unknown device especially in general middle- and large-scaled networks. Namely, according to the above system, even if the device desiring to enter a piconet (of an owner of, e.g. a mobile PC etc) tries to connect with the desired piconet, there might be a high possibility of being rejected when the network implements a security management.

It is a primary object of the present invention, which was devised in view of the problems inherent in the prior art, to provide a technology capable of simply configuring a wireless communication network in a way that ensures the security.

To accomplish the above object, according to one aspect of the present invention, a manager for controlling a wireless network to which a processing device is connected, comprises a registration module registering a processing device connected to the wireless network, a wireless communication module communicating with the processing device, a search module searching a processing device existing within a communicable range through the wireless communication module, and a connection control module connecting, when the searched processing device is registered in the registration module, the searched processing device to the wireless network.

Preferably, in the manager, the search module may further include a search control module having the processing device searched for repeatedly at an interval of a predetermined period.

According to another aspect of the present invention, a processing device connected to a wireless network by a manager for controlling the wireless network, comprises a wireless communication module communicating with the manager, a registration module registering the manager controlling the wireless network to which the processing device is connected, and a connection control module making, when a connection request to the wireless network is received from the registered manager, a connection to the wireless network controlled by the manager.

Thus, the manager searches the processing device registered in the registration module and connects the processing device to the wireless network, whereby an unspecified processing device can be avoided from being connected to the wireless network and the security can be thus ensured.

Further, the manager searches for the processing device existing within the communicable range through the wireless communication module and connects the processing device to the wireless network, and hence the user can connect the processing device to the network simply by bringing this processing device in a predetermined range.

Moreover, the manager searches for the processing device repeatedly at the interval of the predetermined period, and can therefore set proper a waiting time of the user desiring for connecting the processing device by adjusting this predetermined period.

According to still another aspect of the present invention, a device defined as a first device for configuring a wireless network in which a parent device issues a connection command to other device so that the other device is connected as a child device, comprises a registration module registering a second device connected as a child device to the wireless network, a wireless communication module communicating with the second device, a connection control module making, when a connection command is issued from the second device registered as the child device in the registration module, a connection as a child device of the second device, and a reversing module reversing a parental connection relationship with the second device.

According to a further aspect of the present invention, a device defined as a second device for configuring a wireless network in which a parent device issues a connection command to other device so that the other device is connected as a child device, comprises a registration module registering a first device connected as a parent device to the wireless network, a wireless communication module communicating with the first device, a search module searching the first device existing within a communicable range through the wireless communication module, a connection control module connecting, when the first device searched for is registered in the registration module, the first device as a child device of the second device itself by issuing a connection command to the first device, and a reversing module reversing a parental connection relationship with the first device.

Preferably, in the second device, the search module may further include a search control module having the first device searched for repeatedly at an interval of a predetermined period.

Thus, the connection request is given to the first device from the second device connected as the child device, and therefore the first device has no necessity of searching for the second device. On this occasion, the second device connects the first device as the child device but immediately reverse the parent relationship, whereby the network hierarchy (the parent relationship) the first device originally has can be maintained.

The first device may simply accept the connection request given from the second device registered beforehand in the registration module and therefore has no necessity of accepting the connection request from an unspecified device, whereby the function as the parent device can be kept in security.

According to a still further aspect, there is provided a method of actualizing any one of the processes described above.

According to a still further aspect, there is provided a program executed by a computer to actualize any one of the functions described above.

According to a yet further aspect of the present invention, there is provided a storage medium readable by a machine, tangible embodying the program of instructions executable by the machine.

As explained above, according to the present invention, the wireless communication network can be configured in a way that ensures the security.

### BRIEF DESCRIPTION OF THE DRAWINGS

FIG. 1 is a diagram showing a concept of a topology of a Bluetooth-based network;

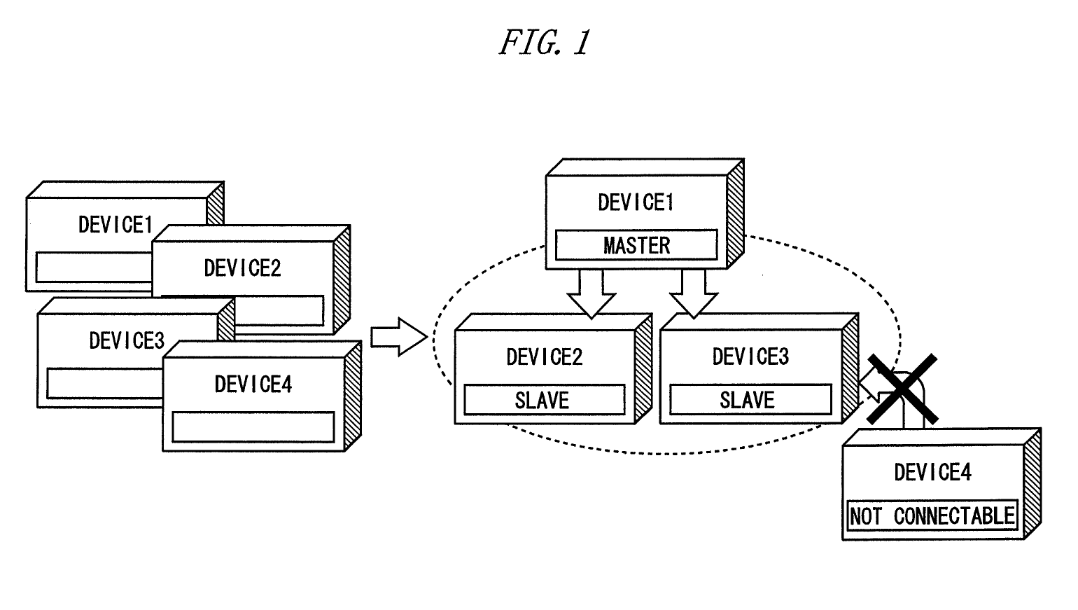

FIG. 2 is a diagram showing a principle of an information system in one embodiment of the present invention;

FIG. 3 is a diagram showing an example of a system architecture thereof;

FIG. 4 is a diagram showing a hardware architecture of a personal computer 11;

FIG. 5 is a diagram showing an example of information retained by a master device 1;

FIG. 6 is a diagram showing an example of information retained by a remote device;

FIG. 7 is a flowchart showing a process of the master device 1 when executing a connection process;

FIG. 8 is a flowchart showing a process of the remote device when executing the connection process;

FIG. 9 is a flowchart showing a process of the master device 1 in a modified example; and

FIG. 10 is a flowchart showing a process of the remote device in the modified example.

### DETAILED DESCRIPTION OF THE PREFERRED EMBODIMENT

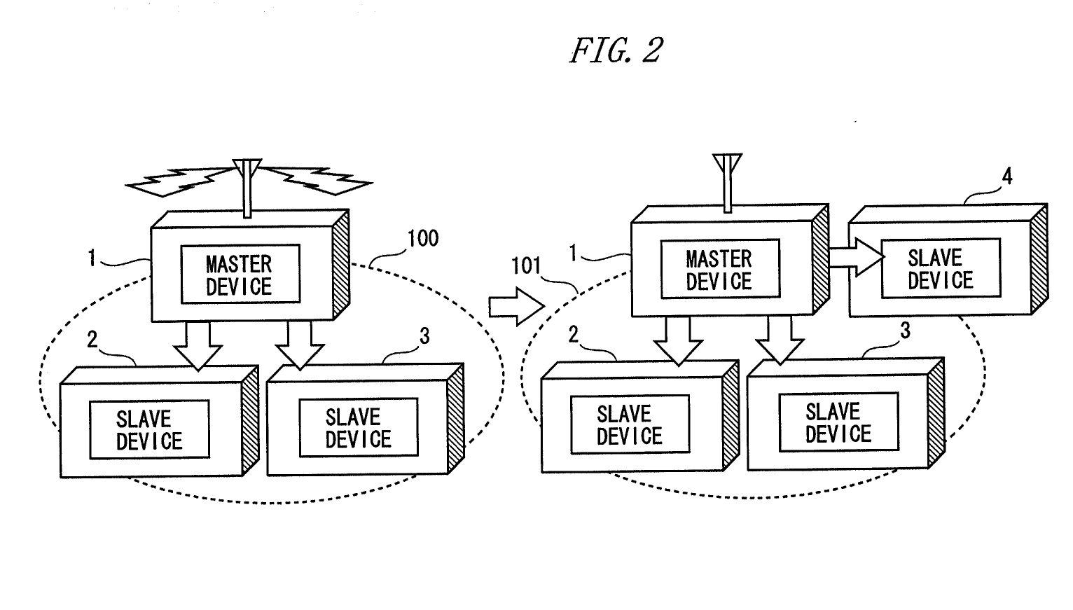

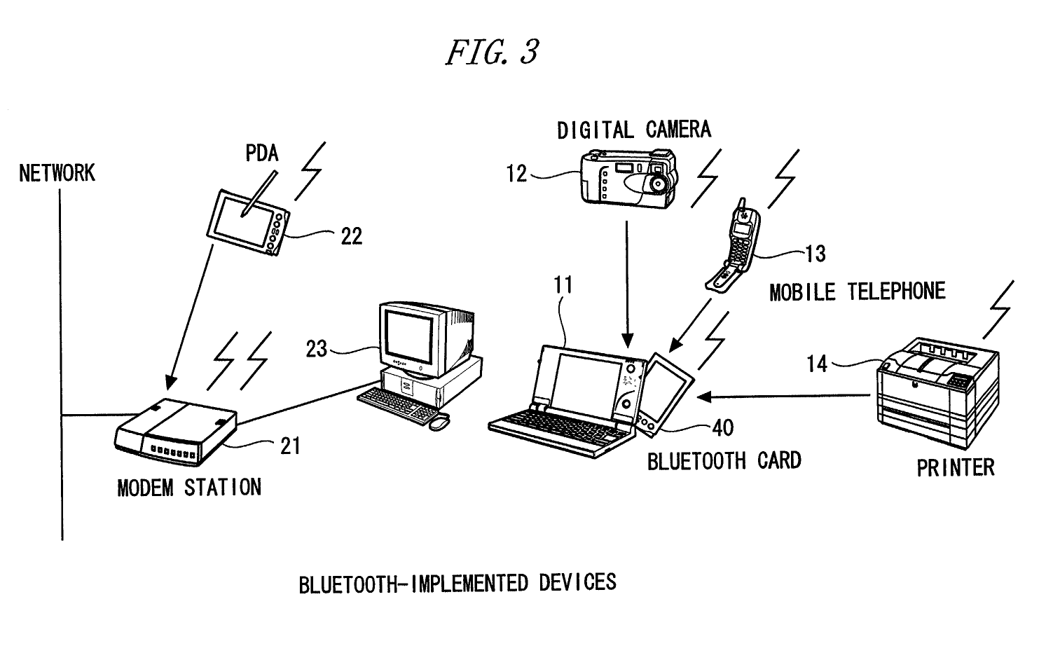

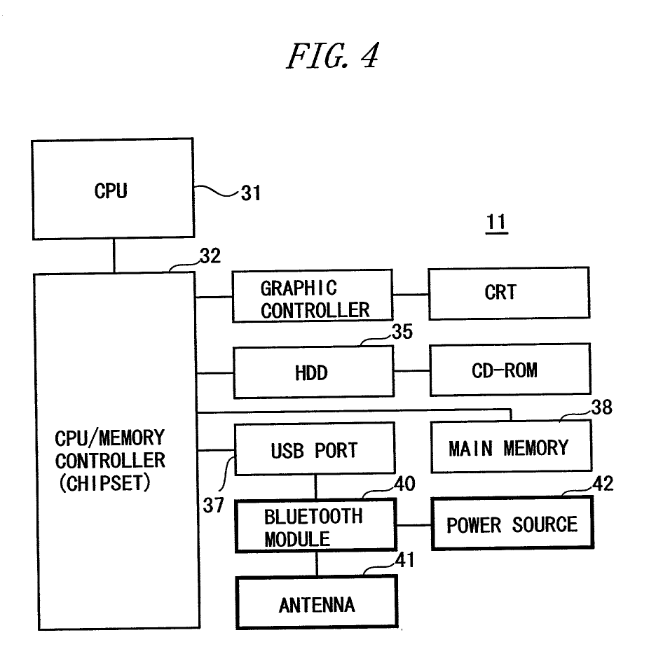

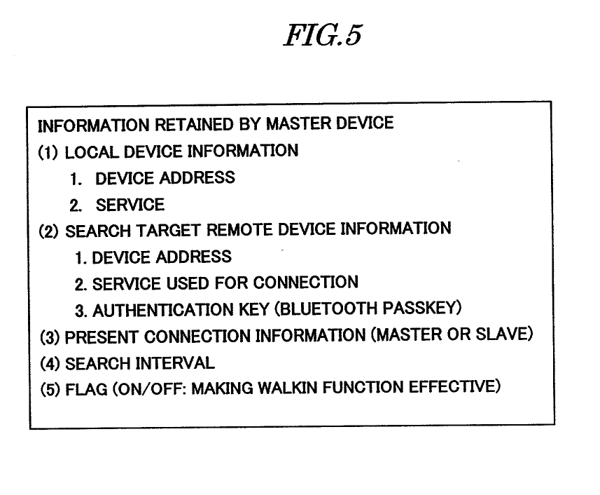

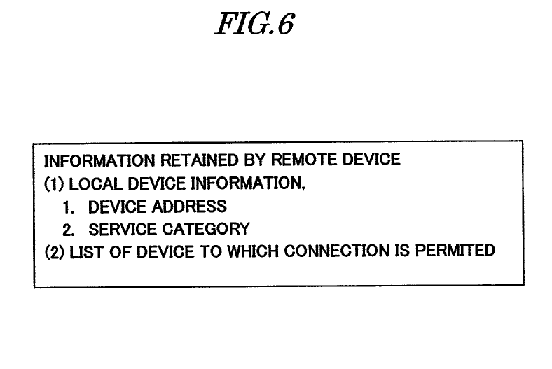

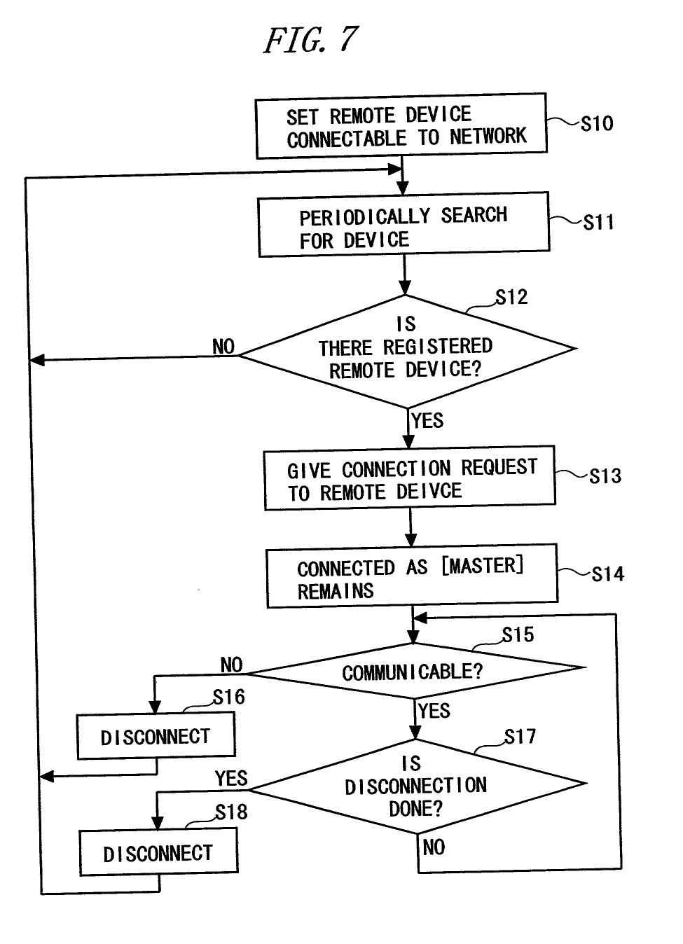

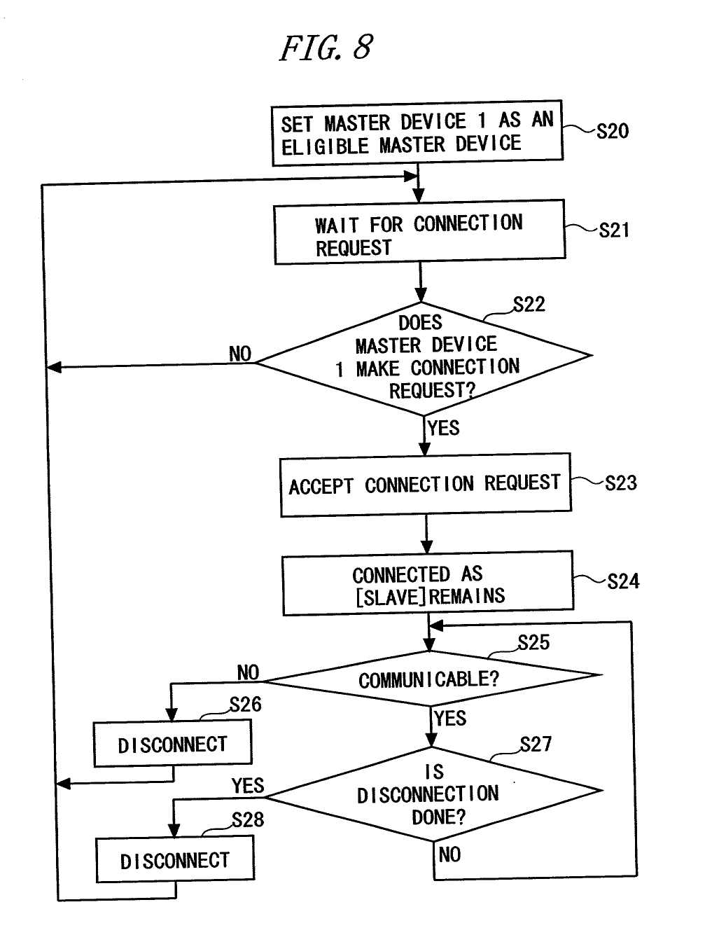

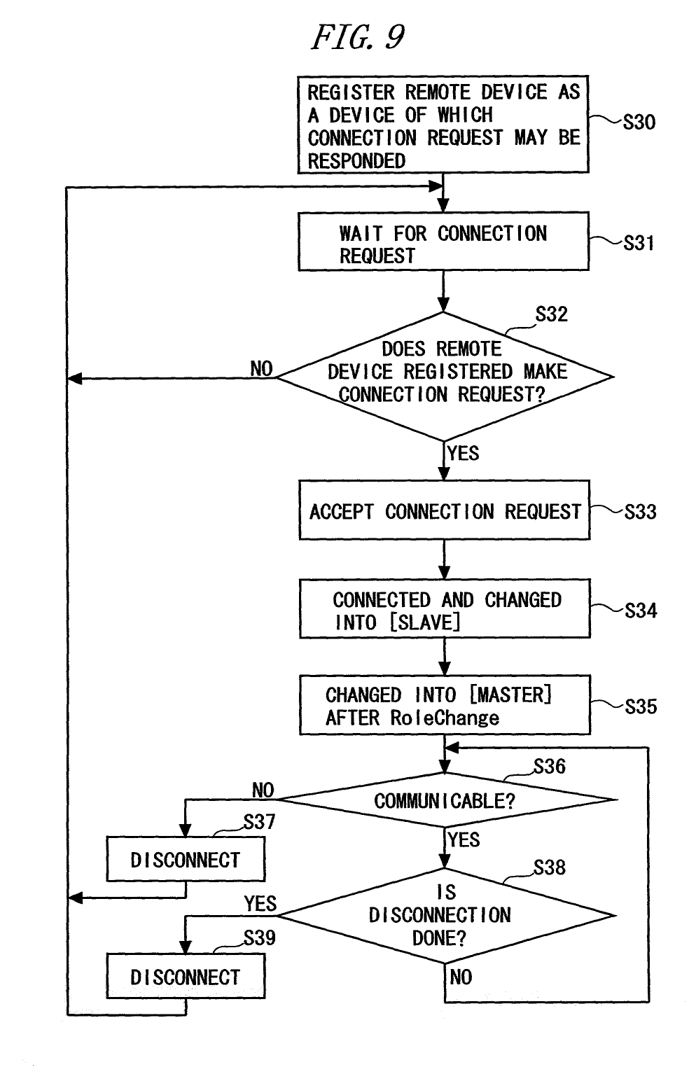

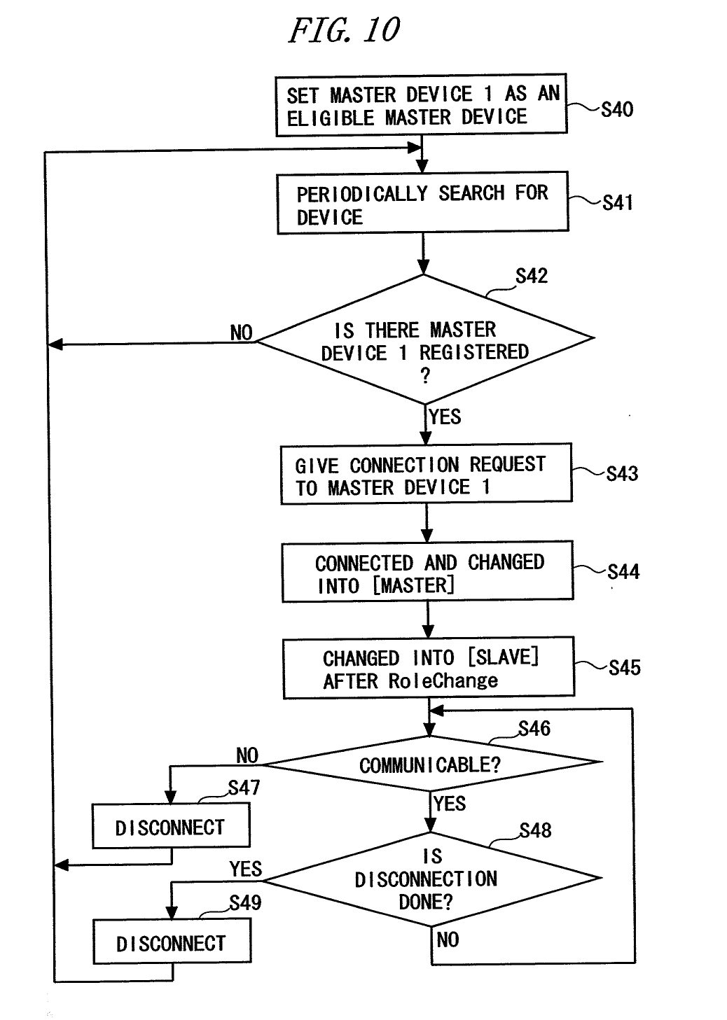

An embodiment of the present invention will hereinafter be described with reference to FIGS. 2 through 10. FIG. 2 is a diagram showing a principle of an information system in one embodiment of the present invention. FIG. 3 shows an example of a system architecture of the present information system. FIG. 4 is a diagram showing a hardware architecture of a personal computer 11 defined as one of devices configuring the present information system. FIG. 5 shows an example of information retained by a master device 1. FIG. 6 shows an example of information retained by a remote device. FIG. 7 is a flowchart showing a process of a master device 1 that controls a network in the present information system. FIG. 8 is a flowchart showing a process of the remote device. FIG. 9 is a flowchart showing a process of the master device 1 in a modified example of the present embodiment. FIG. 10 is a flowchart showing a process of the remote device in this modified example.

<Principle of System>

FIG. 2 is the diagram showing the principle of the present system. Referring to a left illustration in FIG. 2, a master device 1 and slave devices 2, 3 configure a piconet 100. Now the discussion will be focused on a case where, as shown in a right illustration in FIG. 2, a device 4 is newly connected as a slave device to this piconet 100, thus configuring a piconet 101. Note that the devices thus connected to the network are also be called remote devices.

1) A “list of connection-to-network permittee devices” is registered in the master device 1. This is because the connectable devices should be limited for security in the normal network. If all the devices are reliable, however, a definition that “the connections of all the devices are permitted” may be set. It is herein assumed that the “list of connection-to-network permittee devices” contains the devices 4.

2) The master device 1 periodically repeats searching whether the devices registered in the procedure 1) exist within a search range.

3) If the search for the device 4 registered in the procedure 1) is hit within the search range, the master device 1 executes an unconditional connection. This is because the device 4 is defined as a connection permittee device.

4) The device 4 is also registered with the master device 1 as an “unconditional connection permitter device”. Thus, the device 4 is connected to the master device 1 based on what is set in the procedures 3) and 4) without implementing a complicated authentication.

5) When the connection is completed, the master device 1 remaining in its master status and therefore keeps the connections with the slave devices 2, 3. Further, the device 4 is connected to the master device 1 and is therefore connected as a slave device to the network.

<System Architecture>

FIG. 3 shows an example of the system architecture of the information system in this embodiment. This information system can be configured by the devices capable of performing wireless communications on the basis of Bluetooth specifications.

Referring to FIG. 3, one network (piconet) is configured by a personal computer 11 attached with a Bluetooth card, a digital camera 12, a mobile telephone 13 and a printer 14. Further, one network is configured by a modem station 21 connected to a cable network, a personal digital assistant (PDA) 22 and a personal computer 23. In each of the networks, one single device having the master status exists, and the devices other than the master device are in slave status.

FIG. 4 is the diagram showing the hardware architecture of the personal computer 11 shown in FIG. 3. The personal computer 11 includes a CPU 31 for executing a program, a CPU/memory controller 32 (that is also called a chipset) accessing peripheral devices and a memory in accordance with commands given from the CPU 31, and a USB (Universal Serial Bus) port 37. The components and the operations of the personal computer 11 are broadly known nowadays.

A Bluetooth module 40 is connected to the USB port 37 of this personal computer 11, thereby providing a wireless communication function based on the Bluetooth specifications. An antenna 41 and a power source 42 are connected to this Bluetooth module 40, whereby the power is supplied independently of a power source to the CPU 31, even when the CPU 31 is in a non-operating state, the Bluetooth module 40 is communicable with the outside. With this architecture, the CPU 31 transfers and receives communication data from the Bluetooth module 40 as signals of the USB port 37.

An architecture of the Bluetooth module 40 is described in depth on pp.565-571, No.8, VOL.84, the Journal of the Electronics Information and Communications engineers (2001) issued by the Electronics Information and Communications engineers in Japan, written by Toshinari Takayanagi et al.

Note that FIG. 4 shows the hardware architecture of the personal computer 11, however, each of architectures of other devices, e.g., the digital camera 12, the mobile telephone 13, the printer 14, the modem station 21 and the PDA 22 is also substantially the same as FIG. 4 shows.

<Data Structure>

FIG. 5 shows the example of the information retained by the master device 1. The master device 1 retains the information shown in FIG. 5 on a main memory 38 and a hard disk 35 illustrated in FIG. 4. These pieces of information may also be stored on a different type of flash memory etc from these mediums. Namely, the type of the information retaining medium is not limited.

As shown in FIG. 5, the information retained by the master device 1 contains categories such as (1) local device information, (2) search target remote device information, (3) present connection information and (4) a search interval and flag.

The “local device information” is defined as information on the master device 1 itself. The local device information contains a device address and services. The device address is defined as a unique code (a unique bit string) for identifying the device (the master device 1). Precisely, the device address is a code given to the Bluetooth module incorporated into the device. This device address is expressed by a combination of six sets of 2-digit hexadecimal numerical values such as [00:11:22:33:AA:BB] and so on.

The “service” is defined as information indicating which mode (application) the master device can perform the communications with a co-communication remote device in. The services may be categorized such as Serial (line), LAN, fax, a printer, a file server etc.

The “search target remote device information” is information on the search target device (that is called a remote device)searched by the master device 1. This item of information contains a device address and “services available for the connection”. The device address of these categories is a device address of the connection target remote device. Further, the services available for the connection are applications of the communications when establishing the connection.

The “present connection information” is information indicating a state of the connection of the device concerned (the master device 1). “Master” for “Slave” is set in the “present connection information”.

The “search interval” is a time interval at which the remote device is searched for. The “flag” is a flag indicating whether the connection mode shown in this embodiment is implemented or not. Flag-on means that the master device 1 executes searching for the remote device. The master device 1, when discovering the device registered in the “search target remote device information”, connects this remote device to the network.

FIG. 6 shows the example of the information retained by the remote device. The remote device also stores the main memory 38 and the hard disk with the information shown in FIG. 6. This item of information maybe, however, retained on the flash memory and others.

The information retained by the remote device contains categories such as (1) local device information and (2) a connection permitter device list. The “local device information” of these categories is, as in the case shown in FIG. 5, information on the remote device concerned.

The “connection permitter device list” is a list in which to record a device address of the connection permitter device (the master device 1) when the master device 1 makes a connection request.

<Operation>

FIG. 7 shows the process of the master device 1 controlling the network based on the Bluetooth specifications. In this process, the master device 1 connects a remote device as a slave device, e.g., the device 4 to the network.

Note that commands in the following discussion are commands for controlling the Bluetooth module defined in Bluetooth II Specifications book. HCI (Host Controller Interface) is a generic term of the commands defined in Bluetooth, wherein an application program executed by the CPU (e.g., the CPU 31 in FIG. 4) is capable of operating the Bluetooth module (e.g., the Bluetooth module 40 in FIG. 4) by sending an HCI command to the Bluetooth module.

The details of the commands employed in the present invention can be understood by referring to Bluetooth II Specifications book given above, however, the commands and functions thereof will hereinafter be outlined.

HCI_Inquiry:

HCI_Inquiry is a command for indicating a search for the devices existing around the Bluetooth module. Responding to this indication, the Bluetooth module requests each of the peripheral devices to send a response. Then, the application program is notified of the responder device as an event.

HCI_Periodic_Inquiry_Mode:

HCI_Periodic_Inquiry_Mode is an extension version of HCI_Inquiry and is a command for indicating an auto-execution of HCI_Inquiry within the Bluetooth module. With this command HCI_Periodic_Inquiry_Mode executed, the Bluetooth module periodically executes the same process without periodically issuing HCI_Inquiry on the side of the application program.

HCI_Write_Scan_Enable:

HCI_Write_Scan_Enable is a command for specifying two points such as a “response to the search request from the co-communication device” and a “response to the connection request from the co-communication device”. If the former response is specified invalid (no response), there is no response even when exiting in a device search range of other devices, and it follows that the device concerned is not discovered by the co-communication device. If the latter response is specified invalid (no response), it follows that the device concerned is not connected to the co-communication device.

HCI_PIN_Code_{—Request}_Reply:

HCI PIN Code Request Reply indicates sending back a key (passkey) for authentication of the connection. If connecting or connected to the device that needs authenticating, an event for prompting the application program to input a passkey occurs from the Bluetooth module, and hence the application program responds to this event and sends, based on this command, the passkey back to the Bluetooth module.

Parameters of this command are an address of the reply destination device, a passkey byte count and a passkey character string (16 bytes=128 bits). If this passkey is coincident in both of the devices, the connection is authenticated.

In this process, to start with, the connection target remote device is registered as a connection-to-network permittee device in accordance with an operation of the administrator (S10) With this registration done, the device address of the remote device is registered in a predetermined table of the main memory 38.

Next, the master device 1 executes a process of periodically searching for the remote device (S11). In this process, the master device 1 issues the HCI_Inquiry command or the HCI_Periodic_Inquiry_Mode command to the Bluetooth module 40 incorporated into the master device 1 itself so that the Bluetooth module searches for the device.

Note that the master device 1, when using the HCI_Inquiry command, periodically issues this command to the Bluetooth module.

Based on this command, the Bluetooth module executes searching for the device by transmitting to the peripheral devices so that those devices make responses to Inquiry, and notifies the master device 1 (the application program running thereon) of the responder device (the device address and other items of information) as a discovered device.

Next, the master device 1 judges whether the remote device registered above is contained in the searched result (S12). This judgement is done by comparing the device address contained in the searched result with the device address registered in the main memory 38 in the process in S10. If the remote device registered is not contained in the searched result, the master device 1 returns the control back to S11, wherein the periodic search is repeated.

Whereas if the remote device registered is contained in the searched result, the master device 1 requests this remote device to connect (S13). Then, the connection process between the master device 1 and this remote device is executed (S14). Note that the master device 1 keeps its master status in this case.

Note that the connection request contains, though somewhat different depending on the service category when establishing the connection, pieces of information such as a device address of the connection target device, a remote server “channel” (ID for uniquely identifying the service of the co-communication device) for identifying the service to which the connection target device links and a service record “handle” (ID for uniquely identifying the service of the self-device) for identifying the service to which the self-device links.

The service record handle for uniquely identifying the service possessed by the self-device can be obtained by registering beforehand the service opened to other devices in the Bluetooth module of the self-device. Further, the remote server channel can be obtained from the co-communication device through a temporary connection by use of a common protocol such as Service Delivery Protocol for checking what service the co-communication device holds after searching for the device. Further, after establishing the connection with the co-communication device, the service record handle for uniquely identifying the connection takes the same value (a handle prefix or suffix) as a “handle” of this connection request, and this service record handle value is used for uniquely identifying this connection. Then, when disconnected, the connection can be cut off by giving this value to the Bluetooth module.

Next, the master device 1 judges whether to be communicable with that remote device (S15). This is a process of monitoring a disconnection event from the Bluetooth module 40 incorporated into the master device 1 itself. When the disconnection event occurs and if not communicable, the master device 1 accepts the disconnection event (S16) and loops the control back to S11.

Note that the disconnection event from the Bluetooth module 40 occurs when the co-communication device executes the disconnection process and gives no response for a predetermined period of time, when the communications with the co-communication device weaken for the reason that a device distance gets far, and when the power source of the co-communication device is cut off in a state of the connection, and so forth.

Moreover, the disconnection event contains a device address indicating the co-communication device disconnected, a service record handle value (which is transferred to both of the devices when establishing the connection and used identifying this connection, as well as being a unique value (ID) in that state).

The master device 1 accepting this disconnection event executes a process of initializing the settings and various items of information used for the connection with the remote device disconnected such an opening the service record handle related information retained when establishing the connection.

Further, if judged in S15 to be communicable, the master device 1 judges whether the administrator executes the disconnection (S17). If the disconnection is executed, the master device 1 executes the disconnection process (S18), and loops the control back to S11.

Note that the disconnection by the user (administrator) of the master device 1 can be done in a way that specifies an individual remote device or targets all the remote devices.

Further, if the disconnection process is not executed, the master device 1 returns the control to S15. Thus, the master device 1 keeps the connection with the remote device till it comes to a state of being impossible of the communication with the remote device or the disconnection is executed.

FIG. 8 shows the process of the remote device connected as the salve device to the network. In this process, the remote device, to begin with, registers the master device 1 as an eligible “Masters” device (S20). With this process, a device address of the master device 1 is registered in a predetermined table of the remote device.

Further, in this case, the remote device issues an HCI_Write_Scan_Enable command to the Bluetooth module 40 incorporated into the remote device itself. With this command, the Bluetooth module 40 comes to a state of accepting the connection request from the co-communication device.

Next, the remote device waits for the connection request (S21). This is a process for the remote device to wait for an connection event from the Bluetooth module 40.

When the connection event occurs, the remote device judges whether the connection request is a request given from the master device 1 registered in S20 described above (S22). If the connection request is not the request from the master device 1, the remote device returns the control to S21.

Whereas if the connection request comes from the master device 1 registered, the remote device accepts the connection request (S23). In this case, the remote device sends an HCI_PIN_Code_Request_Reply command together with an connection authentication key back to the Bluetooth module 40 incorporated into the remote device itself.

The Bluetooth module 40, in response to the HCI_PIN_Code Request Reply command transmits a connection authentication key (passkey) corresponding to the co-communication device, and checks whether the passkey received from the co-communication device is coincident with the passkey transmitted. Note that if the passkeys are coincident with each other in this check process, a sort of internal passkey known as LinkKey is generated from these passkeys and the information such as the device address etc, and stored. Then, in and after the second connection with the co-communication device connected once, LinkKey stored is exchanged between the devices, and, if the passkeys LinkKey are coincident with each other, a passkey transmission event does not occur. If the passkeys LinkKey are not coincident or do not exist, the passkey transmission event occurs, and hence the passkey exchange process described above is executed on the application layer.

Then, the remote device executes the process of the connection with the master device 1 (S24). As a result, the remote device is connected as a slave device to the network.

Next, the remote device judges whether to be communicable with the master device 1 (S25). This is a process of monitoring the disconnection event from the Bluetooth module 40 incorporated into the remote device itself. When the disconnection event occurs and if not communicable, the device 4 accepts the disconnection event (S26) and loops the control back to S21.

Further, if judged in S25 to be communicable, the remote device judges whether the operator executes the disconnection (S27). If the operator executes the disconnection, the remote device executes the disconnection process (S28), and loops the control back to S21.

Further, if the disconnection process is not executed, the remote device returns the control to S25. Thus, the remote device keeps the connection with the master device 1 till it comes to a state of being impossible of the communication with the master device 1 or the disconnection is executed.

It is to be noted that the content of the disconnection event and the content of the process when accepting the disconnection event in the remote device, are the same as those in the master device 1 described above, and the repetitive explanations are omitted.

<Effect of Embodiment>

As discussed above, according to the information system in this embodiment, the master device 1, when discovering the remote device registered beforehand, connects this remote device as the slave device to the network. Further, the remote device, when the master device 1 registered beforehand makes the connection request, accepts the connection request. Therefore, the wireless communication network can be configured in a way that ensures the security between the master and the slave.

Moreover, for example, the user of each of the devices once sets the connection permitter master device 1 and simply brings the very device in the communicable-with-master-device-1 range, whereby the network can be easily configured (which is termed a WalkIn function in the present information system).

According to this embodiment, the service categories are not particularly limited. In terms of ensuring the security between the master and the slave, however, the function of the information system described above exhibits effects especially when the service category is LAN (Local Area Network) or PAN (Personal Area Network). Note that if the service category is LAN, the master device limits the number of the connectable devices, corresponding to the number of hardware components (Com port count). On the other hand, even if Com port count of the master device is 1, a plurality of devices are permitted to be connected to the master device in PAN.

<Modified Example>

According to the embodiment discussed above, when the master device 1 can periodically search for the connectable remote device, the master device 1 connects this remote device as the slave device to the network. The embodiment of the present invention is not, however, limited to this procedure.

For instance, the remote device request the master device 1 to connect, and the master device 1 may accept this connection request. In this case, the master device 1 temporarily falls into the salve status but may revert to the master status by utilizing a RoleChange function prepared in the Bluetooth specifications.

FIGS. 9 and 10 are flowcharts each showing the connection process in the information system. FIG. 9 shows the flowchart of the master device 1. In this process, at first, the remote device is registered as a device of which the connection request may be responded in accordance with the operation of the administrator (S30). With this registration, a device address of the remote device is registered in a predetermined table of the main memory 38.

Further, in this case, the master device 1 issues the HCI_Write_Scan_Enable command to the Bluetooth module 40 incorporated into the master device 1 itself. With this command, the Bluetooth module 40 comes to a state of accepting the connection request from the co-communication device.

Next, the master device 1 waits for the connection request (S31). This is a process for the master device 1 to wait for an connection event from the Bluetooth module 40.

When the connection event occurs, the master device 1 judges whether the connection request is a request given from the remote device registered above (S32). If the connection request is not the request from the remote device registered, the master device 1 returns the control to S31.

Whereas if the connection request comes from the remote device registered, the master device 1 accepts the connection request (S33). In this case, the master device 1 sends the HCI_PIN_Code_Request_Reply command together with the connection authentication key back to the Bluetooth module 40 incorporated into the master device 1 itself.

Then, the master device 1 executes the process of the connection with that remote device (S34). In this case, the master device 1 temporarily falls into the salve status. Next, the master device 1 executes RoleChange, thereby reverting to the master status (S35). This process is a process for the master device 1 to issue an HCI Switch Role command to the Bluetooth module 40 incorporated into the master device 1 itself. With this process executed, the master device 1 and the remote device execute RoleChange each other through the Bluetooth module 40, wherein the statuses of the slave and the master are replaced with each other. The processes in S36 through S39 are the same as those in S15 through S18 in FIG. 7, and therefore the repetitive explanations are omitted.

FIG. 10 shows the process of the remote device as the salve device. In this process, the remote device, at first, registers the master device 1 as an eligible “Master” device in accordance with an operation of the operator in a predetermined table of the main memory 38 (S40). With this process, a device address of the master device 1 is registered in a predetermined table of the remote device.

Next, the remote device executes a process of periodically searching for the device (S41). In this process, the remote device issues the HCI_Inquiry command or the HCI_Periodic_Inquiry Mode command to the Bluetooth module 40 incorporated into the remote device itself so that the Bluetooth module searches for other remote device (the master device 1).

Next, the remote device judges whether the master device 1 registered in S40 is contained in the searched result (S42). This judgement is done by comparing the device address contained in the searched result with the device address registered in the main memory 38 in the process in S40. If this mater device 1 is not contained in the searched result, the remote device returns the control back to S41, wherein the periodic search is repeated.

Whereas if the master device 1 is contained in the searched result, the remote device requests this master device 1 to connect (S43). With this connection request, the connection process between the master device 1 and the remote device is executed (S44). The remote device temporarily gains the master status in this case.

Next, the remote device RoleChange, thereby reverting to the slave status (S45). This process is a process for the remote device to issue the HCI_Switch_Role command to the Bluetooth module 40 incorporated into the remote device itself. The processes in S46 through S49 are the same as those in S25 through S28 in FIG. 8, and hence the repetitive explanations are omitted. As discussed above, according to the processing procedures shown in FIG. 9 or 10, even when the connection request is given to the device having already bee in the master status from the remote device, the device making the new connection request can be connected to the network by utilizing the RoleChange function in a way that keeps the hitherto-maintained architecture of the network. According to this procedure, the master device 1 can eliminate a futile process such as repeating the search for the remote device, though the remote device that should be connected does not exist in the vicinity thereof.

<Storage Medium Readable by a Machine >

The program executed by a machine to function as the master device 1 or the remote device or the slave device may be recorded on a storage medium readable by a machine, tangible embodying a program. Then, the machine reads and executes the program on this storage medium, thereby functioning as the master device 1 or the remote device or the slave device.

Herein, the storage medium readable by the machine embraces storage mediums capable of storing information such as data, programs, etc. electrically, magnetically, optically and mechanically or by chemical action, which can be all read by the computer. What is demountable out of the machine among those storage mediums may be, e.g., a floppy disk, a magneto-optic disk, a CD-ROM, a CD-R/W, a DVD, a DAT, an 8 mm tape, a memory card, etc.

Further, a hard disk, a ROM (Read Only Memory) and so on are classified as fixed type storage mediums within the computer.

<Data Communication Signal Embodied in Carrier Wave>

Furthermore, the above program may be stored in the hard disk and the memory of the computer, and downloaded to other machines via communication media. In this case, the program is transmitted as data communication signals embodied in carrier waves via the communication media. Then, the machine downloaded with this program can be made to function as the master device 1 or the remote device or the slave device.

Herein, the communication media may be any one of cable communication mediums such as metallic cables including a coaxial cable and a twisted pair cable, optical communication cables, or wireless communication media such as satellite communications, ground wave wireless communications, etc.

Further, the carrier waves are electromagnetic waves for modulating the data communication signals, or the light. The carrier waves may, however, be DC signals. In this case, the data communication signal takes a base band waveform with no carrier wave. Accordingly, the data communication signal embodied in the carrier wave may be any one of a modulated broadband signal and an unmodulated base band signal (corresponding to a case of setting a DC signal having a voltage of 0 as a carrier wave).

What is claimed is:

1. A manager for controlling a wireless network, comprising:
a registration module registering a processing device connected to the wireless network;
a wireless communication module communicating with said processing device;
a search module searching a processing device existing within a communicable range through said wireless communication module; and
a connection control module connecting, when said searched processing device is registered in said registration module, said searched processing device to the wireless network.

2. A manager according to claim 1, wherein said search module further includes a search control module having said processing device searched for repeatedly at an interval of a predetermined period.

3. A processing device connected to a wireless network by a manager for controlling the wireless network, comprising:
a wireless communication module communicating with said manager;
a registration module registering said manager controlling the wireless network to which the processing device is connected; and
a connection control module making, when a connection request to the wireless network is received from said registered manager, a connection to the wireless network controlled by said manager.

4. A device defined as a first device for configuring a wireless network in which a parent device issues a connection command to other device so that said other device is connected as a child device, said first device comprising:
a registration module registering a second device connected as a child device to the wireless network;
a wireless communication module communicating with said second device;
a connection control module making, when a connection command is issued from said second device registered as said child device in said registration module, a connection as a child device of said second device; and
a reversing module reversing a parental connection relationship with said second device.

5. A device defined as a second device for configuring a wireless network in which a parent device issues a connection command to other device so that said other device is connected as a child device, said second device comprising:
a registration module registering a first device connected as a parent device to the wireless network;
a wireless communication module communicating with said first device;
a search module searching said first device existing within a communicable range through said wireless communication module;
a connection control module connecting, when said first device searched for is registered in said registration module, said first device as a child device of said second device itself by issuing a connection command to said first device; and
a reversing module reversing a parental connection relationship with said first device.

6. A device according to claim 5, wherein said search module further includes a search control module having said first device searched for repeatedly at an interval of a predetermined period.

7. A storage medium readable by a machine, tangible embodying a program of instructions executable by the machine to perform method steps for making the machine connect other processing device to a wireless network through a wireless communication module, the method steps comprising:
registering a processing device connected to the wireless network;
searching a processing device existing within a communicable range through said wireless communication module; and
connecting, when said searched processing device is registered in said registration module, said searched processing device to the wireless network.

8. A storage medium readable by a machine tangible embodying a program according to claim to 7, further comprising having said processing device searched for repeatedly at an interval of a predetermined period.

9. A storage medium readable by a machine, tangible embodying a program of instructions executable by the machine to perform method steps for making the machine connected to a wireless network controlled by a manager through a wireless communication module, the method steps comprising:
registering said manager controlling the wireless network to which the machine is connected;
receiving a connection request to the wireless network from said manager registered;
making, when receiving the connection command, a connection to the wireless network controlled by said manager.

10. A storage medium readable by a machine, tangible embodying a program of instructions executable by the machine to perform method steps for making the machine function as a parent device through a wireless communication module in a wireless network where a parent device issues a connection command to other device so that said other device is connected as a child device, the method steps comprising:
registering a device connected as a child device to the wireless network;
receiving a connection command from a device registered as a child device;
making, when receiving the connection command, a connection as a child device of said device; and
reversing a parental connection relationship with said device.

11. A storage medium readable by a machine, tangible embodying a program of instructions executable by the machine to perform method steps for making the machine function as a child device through a wireless communication module in a wireless network where a parent device issues a connection command to other device so that said other device is connected as a child device, the method steps comprising:
registering a device connected as a parent device to the wireless network;
searching for a device existing within a communicable range through said wireless communication module;
connecting, when said device searched for is registered as a parent device, said device searched for as a child device of said machine itself by issuing a connection command to said searched device; and
reversing a parental connection relationship with said connected device.

12. A storage medium readable by a machine tangible embodying a program according to claim 11, further comprising having said device searched for repeatedly at an interval of a predetermined period.

13. A method of connecting a processing device to a wireless network, the method steps comprising:
registering a processing device connected to the wireless network;
searching a processing device existing within a communicable range; and
connecting, when said searched processing device is registered, said searched processing device to the wireless network.

14. A method of connecting a processing device to a wireless network according to claim to 13, further comprising having said processing device searched for repeatedly at an interval of a predetermined period.

15. A method of connecting a processing device to a wireless network, the method steps comprising:
registering a manager controlling the wireless network to which the processing device is connected;
receiving a connection request to the wireless network from said manager registered;
making, when receiving the connection command, a connection to the wireless network controlled by said manager.

16. A method of connecting a device to a wireless network where a parent device issues a connection command to other device so that said other device is connected as a child device, the method steps comprising:
registering a device connected as a child device to the wireless network;
receiving a connection command from said device registered as a child device;
making, when receiving the connection command, a connection as a child device of said device; and
reversing a parental connection relationship with said device.

17. A method of connecting a processing device to a wireless network where a parent device issues a connection command to other device so that said other device is connected as a child device, the method steps comprising:
registering a device connected as a parent device to the wireless network;
searching for a device existing within a communicable range;
connecting, when said device searched for is registered as a parent device, said device searched for as a child device by issuing a connection command to said searched device; and
reversing a parental connection relationship with said connected device.

18. A method of connecting a processing device to a wireless network according to claim 17, further comprising having said device searched for repeatedly at an interval of a predetermined period.
